(19) United States
(12) Patent Application Publication
(10) Pub. No.: US 2025/0061720 A1
(43) Pub. Date: Feb. 20, 2025

(54) OCCUPANCY DETECTION USING MOVEMENT DETECTION AND WIRELESS NETWORK ACTIVITY

(71) Applicant: PLUME DESIGN, INC., Palo Alto, CA (US)

(72) Inventors: Tingyi ZHU, Mountain View, CA (US); Ha DO, Cumming, GA (US); Richard CHANG, Los Altos Hills, CA (US); Charles KRING, Sunnyvale, CA (US); Sean LI, Campbell, GA (US); Timothy NGUYEN, San Jose, CA (US)

(21) Appl. No.: 18/806,760

(22) Filed: Aug. 16, 2024

Related U.S. Application Data
(60) Provisional application No. 63/520,244, filed on Aug. 17, 2023.

(51) Int. Cl. G06V 20/52; H04L 67/50

(52) U.S. Cl. CPC G06V 20/52; H04L 67/535

(57) ABSTRACT

In some implementations, the techniques described herein relate to a method including: classifying motion data and network device usage data in a networked environment; integrating the classified motion data and the network device usage data to create a combined dataset; processing the combined dataset to identify correlations between the motion data and the network device usage data; and using the identified correlations to predict an occupancy state of the environment.

### CROSS-REFERENCE TO RELATED APPLICATIONS

This application claims the benefit of priority from U.S. Provisional Patent Application No. 63/520,244, filed on Aug. 17, 2023, which is incorporated herein by reference in its entirety.

### BACKGROUND

Occupancy detection forms an integral part of modern smart home systems, enabling intelligent automation and facilitating various enhancements in security, comfort, and energy efficiency. It serves as a crucial component in a wide array of applications, including personalized experiences, security improvements, and energy optimization.

### BRIEF DESCRIPTION OF THE DRAWINGS

FIG. 1 is a block diagram illustrating a system for occupancy detection in a smart environment.

FIG. 2 is a flow diagram illustrating a method for detecting motion and micro-motion events within an environment.

FIG. 3 is a flow diagram illustrating a method for monitoring and analyzing network data.

FIG. 4 is a flow diagram illustrating a method for correlating movement and network data to predict occupancy of an environment.

FIG. 5 is a block diagram of a computing device according to some embodiments of the disclosure.

### DETAILED DESCRIPTION

Traditionally, occupancy detection has relied on the utilization of Channel Frequency Response (CFR) data from Wi-Fi links existing between access points and connected devices, a method which primarily offers motion detection capabilities. However, this approach faces certain challenges when applied to the detection of occupancy.

Firstly, motion events are discrete occurrences, whereas occupancy detection demands a more continuous assessment of the state of a home or a specific zone within it. Secondly, the current approach does not effectively account for scenarios where occupants are still, engaged in motionless activities such as sleeping, sitting still, watching television, or working on a computer. During such instances, no motion events are detected, resulting in inaccurate occupancy readings.

Moreover, Wi-Fi motion detection can often misinterpret the movements of neighboring individuals outside the home as occupancy within the home, thereby leading to false positives. Therefore, accurately detecting occupancy requires a more comprehensive and nuanced approach that can effectively capture and interpret the state of a home environment.

To solve these and other technical problems, the present disclosure pertains to a system and method for predicting the occupancy of an environment such as a home or office. The system incorporates a series of client devices and access points that create a Wi-Fi network. The network forms the backbone for an occupancy engine which can identify and interpret both motion data and network activity data. A motion detector component within the occupancy engine analyzes Wi-Fi data to identify movements of various magnitudes. Concurrently, a network activity monitor logs network data, capturing the interactions of client devices within the network. Lastly, an occupancy detector component takes the outputs from both the motion detector and network activity monitor to predict occupancy states.

In some implementations, the techniques described herein relate to a method including: classifying motion data and network device usage data in a networked environment; integrating the classified motion data and the network device usage data to create a combined dataset; processing the combined dataset to identify correlations between the motion data and the network device usage data; and using the identified correlations to predict an occupancy state of the environment.

In some implementations, the techniques described herein relate to a method, wherein the motion data includes data related to micro-motions, the micro-motions indicating movements within the environment that do not significantly change a physical position of a device.

In some implementations, the techniques described herein relate to a method, wherein the network device usage data includes data associated with one or more of a connection of a device to a network, a disconnection of the device from the network, or network requests associated with the device.

In some implementations, the techniques described herein relate to a method, wherein classifying motion data includes detecting motion events using a Digital Signal Processing (DSP) engine based on one or more of Channel State Information (CSI) or Channel Frequency Response (CFR) data received from a Wi-Fi access point.

In some implementations, the techniques described herein relate to a method, wherein integrating the classified motion data and the network device usage data includes aligning the motion data and network device usage data based on timestamp data and using the alignment to determine relationships between network device usage data and motion data.

In some implementations, the techniques described herein relate to a method, wherein processing the combined dataset to identify correlations includes utilizing a plurality of rules, the plurality of rules defining relationships between device usage patterns and detected movements.

In some implementations, the techniques described herein relate to a method, wherein processing the combined dataset to identify correlations includes utilizing a machine learning model, the machine learning model being trained to identify correlations between device usage patterns and detected movements, the training being based on previously recorded and labeled data of device usage and detected movements.

In some implementations, the techniques described herein relate to a method, wherein the occupancy state includes one or more of a presence of humans or a count of humans in the networked environment.

In some implementations, the techniques described herein relate to a non-transitory computer-readable storage medium for tangibly storing computer program instructions capable of being executed by a computer processor, the computer program instructions defining steps of: classifying motion data and network device usage data in a networked environment; integrating the classified motion data and the network device usage data to create a combined dataset; processing the combined dataset to identify correlations between the motion data and the network device usage data; and using the identified correlations to predict an occupancy state of the environment.

In some implementations, the techniques described herein relate to a non-transitory computer-readable storage medium, wherein the motion data includes data related to micro-motions, the micro-motions indicating movements within the environment that do not significantly change a physical position of a device.

In some implementations, the techniques described herein relate to a non-transitory computer-readable storage medium, wherein the network device usage data includes data associated with one or more of a connection of a device to a network, a disconnection of the device from the network, or network requests associated with the device.

In some implementations, the techniques described herein relate to a non-transitory computer-readable storage medium, wherein classifying motion data includes detecting motion events using a Digital Signal Processing (DSP) engine based on one or more of Channel State Information (CSI) or Channel Frequency Response (CFR) data received from a Wi-Fi access point.

In some implementations, the techniques described herein relate to a non-transitory computer-readable storage medium, wherein integrating the classified motion data and the network device usage data includes aligning the motion data and network device usage data based on timestamp data and using the alignment to determine relationships between network device usage data and motion data.

In some implementations, the techniques described herein relate to a non-transitory computer-readable storage medium, wherein processing the combined dataset to identify correlations includes utilizing a plurality of rules, the plurality of rules defining relationships between device usage patterns and detected movements.

In some implementations, the techniques described herein relate to a non-transitory computer-readable storage medium, wherein processing the combined dataset to identify correlations includes utilizing a machine learning model, the machine learning model being trained to identify correlations between device usage patterns and detected movements, the training being based on previously recorded and labeled data of device usage and detected movements.

In some implementations, the techniques described herein relate to a non-transitory computer-readable storage medium, wherein the occupancy state includes one or more of a presence of humans or a count of humans in the networked environment.

In some implementations, the techniques described herein relate to a device including: a processor; and a storage medium for tangibly storing thereon logic for execution by the processor, the logic including instructions for: classifying motion data and network device usage data in a networked environment; integrating the classified motion data and the network device usage data to create a combined dataset, processing the combined dataset to identify correlations between the motion data and the network device usage data, and using the identified correlations to predict an occupancy state of the environment.

In some implementations, the techniques described herein relate to a device, wherein the motion data includes data related to micro-motions, the micro-motions indicating movements within the environment that do not significantly change a physical position of a device.

In some implementations, the techniques described herein relate to a device, wherein classifying motion data includes detecting motion events using a Digital Signal Processing (DSP) engine based on one or more of Channel State Information (CSI) or Channel Frequency Response (CFR) data received from a Wi-Fi access point.

In some implementations, the techniques described herein relate to a device, wherein the occupancy state includes one or more of a presence of humans or a count of humans in the networked environment.

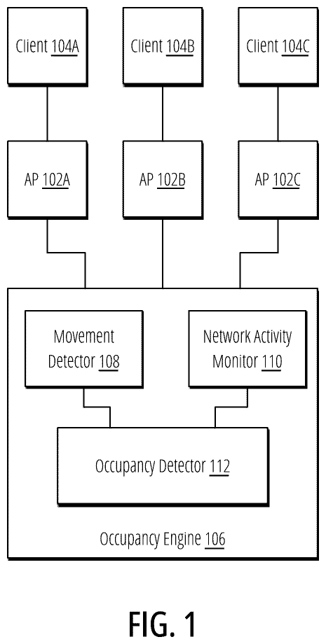

FIG. 1 is a block diagram illustrating a system for occupancy detection in a smart environment.

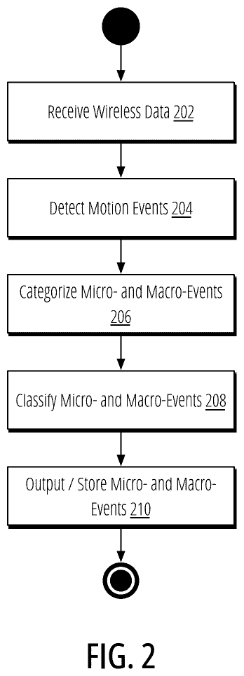

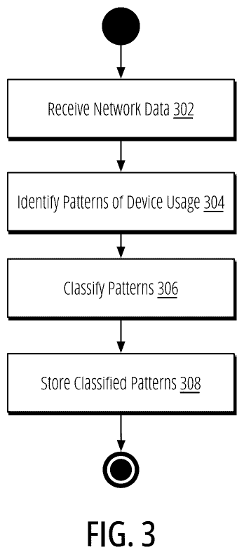

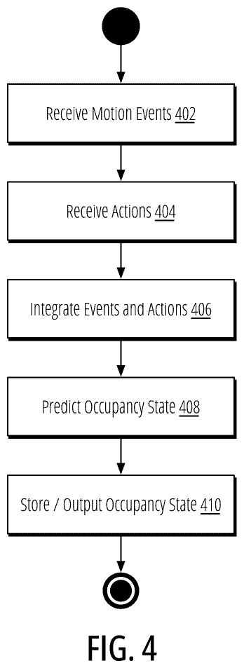

In an implementation, a system includes a plurality of client devices (e.g., client device 104A, client device 104B, and client device 104C) communicatively coupled to access point (AP) devices (e.g., AP 102A, AP 102B, AP 102C). The AP devices may be communicated to other networking hardware (not illustrated) such as switches, routers, modems, etc. and form a Wi-Fi network in an environment (e.g., house, office, etc.). As illustrated, the AP devices may be communicatively coupled to occupancy engine 106. In some implementations, occupancy engine 106 can analyze data related to the various client devices detect both movements of such client devices as well as network activities of these devices. Occupancy engine 106 includes a movement detector 108 that analyzes Wi-Fi data (e.g., CSI or CFR data) to identify micro- or macro-movements. In some implementations, movement detector 108 may comprise a DSP, either implemented as hardware, in software, or a combination thereof. Functional details of movement detector 108 are provided in the description of FIG. 2 which is incorporated herein in its entirety. Occupancy engine 106 also includes a network activity monitor 110 that collects network data from client devices as they connect to, interact with, and disconnect from a wireless network. Functional details of network activity monitor 110 are provided in the description of FIG. 3 which is incorporated herein in its entirety. Occupancy engine 106 includes an occupancy detector 112 that reads movement data from movement detector 108 and network activity from network activity monitor 110 and predicts the occupancy of an environment associated with the access points. Functional details of occupancy detector 112 are provided in the description of FIG. 4 which is incorporated herein in its entirety.

In some implementations, occupancy engine 106 may be implemented as various locations in the system. For example, occupancy engine 106 can be implemented in an AP, in a network device (e.g., switch, router, modem, etc.) or in a remove server (e.g., in a cloud implementation). In some implementations, some features or modules of occupancy engine 106 may be distributed. For example, movement detector 108 and network activity monitor 110 may be distributed to APs; by contrast, occupancy detector 112 may be implemented in a centralized manner (e.g., in a remote data center or network device).

In the illustrated environment, the system includes a plurality of client devices including client device 104A, client device 104B, and client device 104C. The client devices may be any type of Wi-Fi-enabled devices commonly found in homes, offices, or other environments where wireless connectivity is required. The client devices can include, but are not limited to, personal computers, laptops, smartphones, tablets, smart TVs, smart home devices like thermostats or light systems, IoT sensors, security cameras, or other Wi-Fi-enabled electronic devices. Each of the client devices may support one or more communication protocols, such as various IEEE 802.11 protocols (described herein). The client devices may also include additional features, such as multi-band capabilities, different power saving modes, and security features, among others. These client devices connect to the Wi-Fi network by establishing a wireless connection with one or more APs (e.g., AP 102A, AP 102B, AP 102C) within range, in order to communicate with other devices within the network or to access services available on the Internet.

As illustrated, the client devices are communicatively coupled to access points including, but not limited to, AP 102A, AP 102B, and AP 102C. These APs provide Wi-Fi connectivity and data transmission within the network. They can function as standalone devices or be integrated within larger network infrastructures such as routers or network switches. APs are typically dispersed strategically within the environment, offering coverage over defined areas to ensure optimal connectivity for all client devices. APs are capable of managing multiple concurrent connections from various client devices and adhere to a range of communication protocols such as IEEE 802.11. Each AP can provide dual or multi-band capabilities to cater to various devices and applications, often operating within the 2.4 GHz and 5 GHz frequency bands. APs can also be equipped with robust security features such as WEP, WPA, or WPA2 protocols to maintain data integrity and confidentiality within the network. Advanced features such as beamforming may also be incorporated to enhance signal quality and device connectivity.

In some implementations, movement detector 108 can receive Wi-Fi data (e.g., CSI or CFR data) from the APs and analyze the Wi-Fi data to identify and distinguish between micro- and macro-movements within the environment. It may do this by processing the Wi-Fi data using various digital signal processing (DSP) techniques. For instance, Fast Fourier Transforms (FFT), Convolution, and other DSP techniques may be employed to process the raw CSI and CFR data, which can help detect variations that may correspond to movements within the Wi-Fi field.

In some implementations, movement detector 108 can comprise a DSP engine, which can be implemented as hardware, software, or a combination thereof. For example, movement detector 108 could be implemented using a dedicated DSP chip, a general-purpose microprocessor running a DSP software program, or a combination of both. Regardless of the implementation, the DSP engine can transform the raw CSI/CFR data into a format suitable for motion detection and classification.

In some implementations, movement detector 108 can use advanced filtering algorithms to separate micro-motions from macro-motions. This can involve a thresholding technique where movements that induce relatively small changes in the CSI or CFR data are classified as micro-motions, while movements that induce larger changes are classified as macro-motions. In some cases, machine learning models, such as Support Vector Machines (SVM), Decision Trees, or Neural Networks, may be utilized to further improve the accuracy of this classification process.

In some implementations, movement detector 108 may include a memory or storage component for storing the processed and classified motion events for later use by other components of the system, such as the occupancy detector 112. This storage component can include a local or remote database, file system, or other types of data storage and retrieval systems.

In some implementations, network activity monitor 110 can track and analyze network data received from the APs related to the activities of client devices within the networked environment. This network data can include information related to when and how devices connect to and interact with the Wi-Fi network, what types of network services they use, when they disconnect from the network, and other related details. These pieces of network data can serve as inputs to identifying patterns of device usage.

In some implementations, network activity monitor 110 may include mechanisms for capturing and analyzing temporal patterns of network data. This can involve windowing techniques or similar approaches to group related bursts of network activity together. For example, a group of network actions happening within a short timeframe may indicate a correlated activity, such as an occupant starting their day or engaging in a specific routine.

In some implementations, network activity monitor 110 can classify the identified patterns of device usage into one or more categories. These categories can reflect different types of activities or behaviors of occupants within the environment, such as working, sleeping, cooking, and the like. The classifications can be based on rules or algorithms that associate certain patterns of device usage with certain categories. For instance, if a smart coffee maker and a smart TV both show increased network activity early in the morning, the system can classify this pattern as an “awake” or “morning routine” activity.

In some implementations, network activity monitor 110 may include a data storage component for storing the classified network actions. This data storage component can provide a historical record of network activity patterns, which can be used for further analysis and to help the occupancy detector 112 predict future occupancy states. This storage component can include a local or remote database, a file system, or other types of data storage and retrieval systems.

The occupancy detector 112 predicts the occupancy state of an environment by integrating the movement data from the movement detector 108 and the network activity data from the network activity monitor 110. It can identify correlations between the movement data and the network activity data. For instance, if a micro movement event is detected at 2:00 AM and there's a drop in network activity across devices, occupancy detector 112 can correlate these two events and predict that the occupant is sleeping. Conversely, if a macro motion event is detected at 7:00 AM and there's a surge in network activity from multiple devices, these can be correlated by occupancy detector 112 to predict that the occupant is awake.

The occupancy detector 112 may use various methods for determining these correlations. In some implementations, occupancy detector 112 can use a rules-based system where certain combinations of movement and network activity data trigger specific occupancy state predictions. For instance, a rule can specify that macro motion plus network activity from a smart coffee maker indicates that the occupant is awake and at home. Alternatively, in some implementations, the occupancy detector 112 can use machine learning algorithms to determine correlations. These algorithms can be trained on historical data to recognize patterns that predict certain occupancy states.

In some implementations, the occupancy detector 112 uses the identified correlations to predict an occupancy state. This can involve generating a confidence score for each potential occupancy state and selecting the state with the highest score. For instance, if the data shows a macro motion event and a burst of network activity from multiple devices, the system can assign a high confidence score to the “occupant is awake and at home” state and a low confidence score to the “occupant is away” state.

The predicted occupancy state can then be outputted for use by other systems or stored for future use. For example, the system can use the predicted occupancy state to adjust smart home settings, trigger alerts, or inform other automated processes. If the predicted state is stored, it can be used to analyze trends over time, refine the prediction algorithms, or provide data for other uses. This storage can take place in a local or remote database, a file system, or other types of data storage and retrieval systems.

FIG. 2 is a flow diagram illustrating a method for detecting motion and micro-motion events within an environment. In the method, a DSP engine receives CFR and CSI data from the Wi-Fi access point, then applies signal processing techniques to detect both gross motions and micro-motions within the home.

In step 202, method can include receiving wireless data from a Wi-Fi access point. In some implementations, the wireless data may include one or both of CSI and CFR data, which are components in the Wi-Fi communication system that represent the characteristics and behavior of a wireless channel.

In some implementations, CSI is a measure of the communication channel's properties, specifically its response to a Wi-Fi signal. It can provide information about the path a signal has taken, its delay, and the degree of interference or multipath effects. Thus, CSI can be used to detect subtle changes in the environment, such as those caused by motion. CFR, on the other hand, can provide a frequency-domain representation of the channel's response. It contains information about the magnitude and phase shift of each frequency component in a Wi-Fi signal, reflecting the impact of the communication channel on these frequencies.

In some implementations, CSI and CFR data is often collected by a Wi-Fi access point or a router within the home network. These devices are capable of monitoring Wi-Fi signals and extracting relevant channel information. This data can then be passed on to a DSP engine for further analysis. In some implementations, the DSP engine can be implemented in various ways, depending on the specific requirements of the system. On the hardware side, it can be a dedicated DSP chip that is specialized for signal processing tasks. On the software side, the DSP engine can be a software module running on a general-purpose processor. This approach offers flexibility, as the software can be updated or modified to incorporate new algorithms or techniques. Furthermore, the DSP functions can be implemented within a larger system, allowing them to work in conjunction with other processes, such as network management or device control. In some implementations, the DSP engine could also be implemented as a combination of hardware and software. This could allow for a balance between the efficiency of dedicated hardware and the flexibility of software, providing a tailored solution for occupancy detection.

In step 204, the method can include detecting motion events in the received data using a DSP engine.

In some implementations, motion events can be detected by identifying changes in the CSI and CFR data that correspond to movements within the Wi-Fi signal's environment. In a typical wireless communication scenario, the CSI and CFR values would remain relatively stable when there is no movement. However, any movement in the vicinity of the Wi-Fi signal path, such as a person moving or a door opening, can cause a change in these values.

For instance, consider a scenario where the CSI and CFR values are initially steady at −70 dBm and 300 Hz, respectively. When a person moves within the Wi-Fi signal path, the CSI can fluctuate to −65 dBm due to the signal strength change caused by the movement. Similarly, the CFR can also change to 280 Hz due to the slight shift in the frequency response. These variations from the initial steady state can be identified by the DSP engine as a motion event.

In some implementations, the DSP engine can employ a range of techniques to analyze the CSI and CFR data. This can include Fourier transforms to convert the time-domain signals into frequency-domain signals, filtering techniques to remove noise or unwanted components, and statistical analysis to identify significant changes. The DSP engine may also use correlation techniques to compare the current CSI and CFR values with previously recorded values. This can help determine if the observed changes in the data are due to motion events or other factors such as temporary signal interference.

In some implementations, the DSP engine may be configured to handle different types of motion. For example, it can have different processing algorithms for detecting large-scale movements (macro motions) such as a person walking across a room, versus smaller-scale movements (micro motions) such as a person breathing or shifting slightly while sitting. Specific ways to differentiate between the same are discussed in more detail below.

In step 206, the method can include categorizing micro-motions and macro-motions within the detected motion events.

Micro-motions, such as a person rolling over during sleep, can create subtle fluctuations in the CSI/CFR data. In such scenarios, the variations in the CSI/CFR data can be small and the patterns may be less distinct compared to more significant movements. However, through signal processing techniques, these micro-motions can still be identified. For example, filtering algorithms may be applied to highlight small changes in the signal that can otherwise be masked by noise or other larger motions.

One type of filtering algorithm includes a band-pass filter. These filters allow signals within a certain frequency range to pass through while attenuating signals outside this range. In the context of detecting micro-motions, the filter can be configured to allow through the frequency ranges that are most likely to contain the subtle variations caused by such motions. Another type of filtering algorithm that can be used is adaptive filtering. Unlike traditional filters that have fixed characteristics, adaptive filters adjust their properties based on the input signal. This makes them particularly useful in situations where the signal characteristics are not stationary and may change over time, such as when trying to detect micro-motions in a noisy environment. Another type of filtering algorithm that can be used is wavelet transforms. They can be used to analyze the CSI/CFR data at different scales, which can be useful for identifying micro-motions that can cause subtle changes in the signal over short periods of time. Another type of filtering algorithm that can be used are statistical filtering techniques such as Kalman filters or particle filters can be used. These techniques are particularly useful when the system being monitored (in this case, the movement of objects/people within the range of a Wi-Fi network) can be modeled as a dynamic system with some degree of uncertainty. These filters work by predicting the future state of the system based on the current state and the incoming data, and then updating these predictions as new data comes in.

In addition, advanced machine learning algorithms can be used to identify the patterns associated with micro-motions. For instance, machine learning models trained on CSI/CFR data from multiple scenarios involving micro-motions (like a person breathing, rolling over in bed, or subtly shifting position while sitting) can recognize the subtle patterns indicative of these small movements. When applied to real-time data, these models can help identify the presence of micro-motions. For example, support vector machine (SVM), convolutional neural network (CNN), recurrent neural network (RNN) (such as long short-term memory) models may be used.

On the other hand, macro-motions may be easier to detect as they cause more significant and distinguishable changes in the CSI/CFR data. Walking across a room, opening a door, or moving a large object can cause significant changes in the Wi-Fi signal paths, leading to distinct patterns in the CSI/CFR data.

Distinguishing between micro-motions and macro-motions can be done based on the amplitude and pattern of the changes in CSI/CFR data. For example, thresholding techniques can be used where movements causing changes beyond a certain threshold are classified as macro-motions while those causing smaller changes are classified as micro-motions. Machine learning models trained on both types of movements can further improve the accuracy of this classification by identifying the unique patterns associated with micro and macro-motions.

In step 208, the method can include classifying the micro and macro motions using motion model.

In some implementations, step 208 can include combining sequential movements (micro or macro) and classifying the sequential movements. In some implementations, the model can additionally consider the time of day or other extrinsic factors. For example, at nighttime in a home there are generally few movements. Thus, the method can aggregate any micro movements at night and determine if these micro movements over a normal sleep period correspond to a sleeping person (and thus occupancy). Similarly, sporadic small-scale motions could be indicative of a person performing stationary activities, such as working on a computer or watching TV. In some implementations, the model can take the form of a rules-based model while in other cases a machine learning model may be used.

In step 210, the method can include outputting and/or storing the classified motion events.

In some implementations, the results of the motion detection and classification processes are stored locally for immediate use. This could involve storing the raw motion data, the processed motion signals, and/or the output of the motion classification algorithms. The motion data may be stored in a structured format that facilitates further analysis and decision-making. For instance, the data can be organized by time and type of motion (micro vs. macro), allowing easy retrieval of specific subsets of the data.

In some implementations, the motion data can also be outputted to external systems for further processing or to trigger specific actions. For example, the system can send a notification to a homeowner's smartphone if it detects an unexpected motion event in the middle of the night. Alternatively, the system can feed the motion data into a home automation system, which could use this information to control various aspects of the home environment, such as lighting, heating, or security systems. The precise form of the output will depend on the requirements of the specific application and the capabilities of the external systems.

FIG. 3 is a flow diagram illustrating a method for monitoring and analyzing network data. In some implementations, the method of FIG. 3 can be implemented in parallel with that of FIG. 2, generating two data sets representing movements (micro and macro) as well as network actions. The method of FIG. 2 generally includes tracking devices connecting to or disconnecting from the Wi-Fi network, analyzing patterns of network traffic, and using this information to generate network actions that can later be correlated with movements.

In step 302, the method can include receiving network data related to device activities in a networked environment. The network data used in step 302 can be collected from a variety of sources, such as routers, network switches, or even directly from the devices themselves.

In some implementations, network data in step 302 can refer to data that characterizes the activity of various computing devices in a networked environment, such as a home or an office. This data can be generated through normal operation of devices and transmitted over the network. For instance, this data could include timestamps of device connections and disconnections, the volume and type of network traffic generated by each device, and so forth. In some implementations, network data could also include more specific information, such as the specific servers or websites that devices are accessing. For instance, a refrigerator continuously pinging a manufacturer uniform resource locator (URL) or Internet Protocol (IP) address could be a part of the network data that is received.

This network data can provide a wealth of information about the occupancy of the environment. For example, if a phone frequently connects to the network during certain hours, it may indicate the presence of a person. On the other hand, a device that is consistently connected, like a smart refrigerator, may not provide direct information about occupancy but can add context to other data points. Further, as will be discussed, the “always on” nature of devices can confound traditional occupancy detection means since an environment will frequently include significant network activity even when no humans are present.

In some implementations, the network data can also be used to provide a broad categorization of each device within a network. In some implementations, as described co-pending application bearing Attorney Docket No. 201221-036750, to further refine the type of device based on movement data.

In step 304, the method can include analyzing the network data to identify a pattern of device usage within the networked environment.

In some implementations, a pattern of device usage refers to the detection of correlated activities of a device on the network that appear as bursts or sequences of network interactions. These patterns can include data requests, data transmissions, and signals emitted during device activation or deactivation.

As one example, a device connecting to a Wi-Fi network or disconnecting from a Wi-Fi network may include a sequence or pattern of network activity. As another example, a pattern can be observed when a device, such as a smart TV, is turned on and begins streaming video content. This can be reflected in the network data as a burst of high-volume data transfer from the smart TV to a particular external server (e.g., a streaming service), which can be seen as an identifiable pattern of device usage. In another example, an IoT device, such as a smart refrigerator, can regularly ping its manufacturer's server to upload usage data and download updates. The frequency and timing of these pings could constitute a pattern that provides insight into the device's operational state.

In step 306, the method can include classifying the patterns of device usage into one or more categories.

The classification may be based on various factors such as the type of device involved, the network activity, the frequency and duration of the pattern, among others. For example, a pattern involving frequent data requests from a smartphone may be classified as a “mobile device interaction” category. Meanwhile, regular pings from a smart refrigerator to its manufacturer's server could fall under an “IoT device update” category. Further, a common sequence of network communications establishing a Wi-Fi link can be categorized as “device connecting.” In some cases, machine learning techniques can be used to automate this classification process. For instance, a supervised learning algorithm could be trained on a labeled dataset of network activity patterns and their corresponding categories. Once trained, this algorithm could automatically classify new patterns into the established categories.

In step 308, the method can include storing the classified actions in a network action database. In some implementations, the classified patterns may be stored in any data storage system or database, such as a relational database management system (RDBMS), a NoSQL database, a flat file database, a distributed database, or a cloud-based storage system. The stored data may include details about each classified pattern, such as the devices involved, the time and duration of the device usage, the type of network activity, and the classification category. This stored data can serve as the foundation for more advanced occupancy detection techniques described in the subsequent figures and steps.

FIG. 4 is a flow diagram illustrating a method for correlating movement and network data to predict occupancy of an environment.

In step 402, the method can include receiving classified motion events from the DSP engine. In some implementations, the method can retrieve the classified micro- and macro-movements output from the DSP engine, described in more detail in the description of FIG. 2, which is not repeated herein. In some implementations, each classified motion event is timestamped based on its detected time.

In step 404, the method can include receiving classified actions from the network action database. In some implementations, the method can retrieve the classified actions identified using the method of FIG. 3, the description of which is not repeated herein. In some implementations, each classified actions can likewise be timestamped based on their detected time.

In step 406, the method can include integrating the classified motion events and the actions of device usage. This step of data integration may be accomplished using various data aggregation, merging, or blending techniques, depending on the specific requirements of the system.

In one implementation, classified motion events may include various types of data, such as timestamps of detected motions, their type (micro or macro), and the duration of the motion. The actions of device usage may include data like the timestamps of device activation, type of device, network activity, and the duration of device usage. These two data streams can be integrated based on their temporal alignment, that is, matching the timestamps from both sources.

For example, suppose a micro motion event is detected at 2:00 AM, and concurrently, a drop in network activity across devices. In this case, the data integration process would align these two events based on their occurrence at the same timestamp. Such a correlation may indicate a sleeping user. Conversely, instead of a drop in network activity there is a spike in network connectivity with a streaming service, it could indicate a user watching television. As another example, if a macro motion is detected at 7:00 AM, and there's a surge in network activity involving multiple devices (e.g., smartphone, smart coffee maker, smart TV), these events would be aligned based on their shared timestamp. Such a correlation may indicate that a user is awake.

In some implementations, the correlations can include multiple types of actions and movements combined together. For example, the method may detect a macro-movement at 12:00 PM and record network activity from a smart television as well as an exercise device. In some implementations, as will be discussed, the method can reference the locations of these devices to identify two occupants based on the locations of the devices and the presence of a macro-movement.

In step 408, the method can include processing the integrated data to determine correlations between device usage and movement and predicting an occupancy state. In some implementations, the method can leverage machine learning algorithms to learn these correlations, while in other cases, a rules-based approach may be employed. In some implementations, both techniques can be used. For example, a rules-based approach can be used to determine if a matching rule exists and, if not, an ML approach can be used.

In the case of a machine learning-based approach, a variety of algorithms can be employed, such as regression models, decision trees, random forests, or deep learning architectures. These models can be trained using a set of labeled data, which include instances of different occupancy states and the corresponding network and movement events. The model's task is to learn the relationships between the input data (network actions and movement events) and the output (occupancy state or amount). Once the model is trained, it can process new integrated data to determine correlations and predict the occupancy state. Taking the examples given previously, the machine learning model can learn that when a micro-motion is detected at 2:00 AM and there is a concurrent drop in network activity, this likely indicates a sleeping user. Similarly, if a micro-motion is detected at the same time as a spike in network connectivity with a streaming service, this can indicate a user who is awake and watching television.

In the case of a rules-based system, the correlations are determined by a set of predefined rules. These rules can be created based on domain knowledge, expert input, or through analysis of historical data. For example, a rule can be established that if a macro-motion event is detected at 7:00 AM and there is concurrent network activity across multiple devices (smartphone, smart coffee maker, smart TV), this likely indicates that a user has just woken up. In another rule, a macro-motion detected at 12:00 PM, along with network activity from a smart television and an exercise device, can indicate two occupants in the environment.

In step 410, the method can include outputting the predicted occupancy state or storing the prediction for future use.

In some implementations, the output can be a real-time display on a user interface. The user interface may be part of a home automation system, a security system, or any device capable of receiving and displaying the data. For instance, the occupancy state could be visually represented on a smartphone app or a dedicated screen on a smart home hub. The real-time display may include not only the current occupancy state but also a history of past states, as well as predictions for future states based on historical data and trends.

In other implementations, the predicted occupancy state can be sent to other systems or applications for further action. For example, an occupancy state indicating that no one is home could trigger a security system to enter a heightened state of alertness, or it could signal a smart thermostat to lower the heat or air conditioning to save energy.

In yet other implementations, the predicted occupancy state can be stored for future use. This could be useful for creating a historical record of occupancy states, which can be analyzed to understand patterns over time, optimize energy usage, or enhance security measures. The stored data may be kept in a local database or it could be stored remotely, in a cloud-based system, for example.

Also, in some cases, the method can include a feedback loop, where the outputted predictions are compared with actual occupancy states (once they are known), and the difference between the prediction and reality is used to adjust and improve the prediction model. This continuous refinement of the prediction model can make the system more accurate and reliable over time.

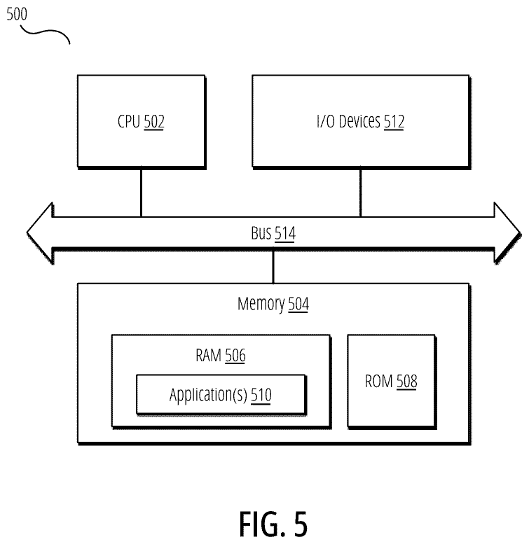

FIG. 5 is a block diagram of a computing device according to some embodiments of the disclosure.

As illustrated, the device 500 includes a processor or central processing unit (CPU) such as CPU 502 in communication with a memory 504 via a bus 514. The device also includes one or more input/output (I/O) or peripheral devices 512. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 502 may comprise a general-purpose CPU. The CPU 502 may comprise a single-core or multiple-core CPU. The CPU 502 may comprise a system-on-a-chip (SoC) or a similar embedded system. In some embodiments, a graphics processing unit (GPU) may be used in place of, or in combination with, a CPU 502. Memory 504 may comprise a memory system including a dynamic random-access memory (DRAM), static random-access memory (SRAM), Flash (e.g., NAND Flash), or combinations thereof. In one embodiment, the bus 514 may comprise a Peripheral Component Interconnect Express (PCIe) bus. In some embodiments, the bus 514 may comprise multiple busses instead of a single bus.

Memory 504 illustrates an example of a non-transitory computer storage media for the storage of information such as computer-readable instructions, data structures, program modules, or other data. Memory 504 can store a basic input/output system (BIOS) in read-only memory (ROM), such as ROM 508 for controlling the low-level operation of the device. The memory can also store an operating system in random-access memory (RAM) for controlling the operation of the device.

Applications 510 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 506 by CPU 502. CPU 502 may then read the software or data from RAM 506, process them, and store them in RAM 506 again.

The device may optionally communicate with a base station (not shown) or directly with another computing device. One or more network interfaces in peripheral devices 512 are sometimes referred to as a transceiver, transceiving device, or network interface card (NIC).

An audio interface in peripheral devices 512 produces and receives audio signals such as the sound of a human voice. For example, an audio interface may be coupled to a speaker and microphone (not shown) to enable telecommunication with others or generate an audio acknowledgment for some action. Displays in peripheral devices 512 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 512 may comprise any input device arranged to receive input from a user. An illuminator in peripheral devices 512 may provide a status indication or provide light. The device can also comprise an input/output interface in peripheral devices 512 for communication with external devices, using communication technologies, such as USB, infrared, Bluetooth®, or the like. A haptic interface in peripheral devices 512 provides tactile feedback to a user of the client device.

A GPS receiver in peripheral devices 512 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

We claim:

1. A method comprising:
classifying motion data and network device usage data in a networked environment;
integrating the classified motion data and the network device usage data to create a combined dataset;
processing the combined dataset to identify correlations between the motion data and the network device usage data; and
using the identified correlations to predict an occupancy state of the environment.

2. The method of claim 1, wherein the motion data includes data related to micro-motions, the micro-motions indicating movements within the environment that do not significantly change a physical position of a device.

3. The method of claim 1, wherein the network device usage data includes data associated with one or more of a connection of a device to a network, a disconnection of the device from the network, or network requests associated with the device.

4. The method of claim 1, wherein classifying motion data comprises detecting motion events using a Digital Signal Processing (DSP) engine based on one or more of Channel State Information (CSI) or Channel Frequency Response (CFR) data received from a Wi-Fi access point.

5. The method of claim 1, wherein integrating the classified motion data and the network device usage data comprises aligning the motion data and network device usage data based on timestamp data and using the alignment to determine relationships between network device usage data and motion data.

6. The method of claim 1, wherein processing the combined dataset to identify correlations includes utilizing a plurality of rules, the plurality of rules defining relationships between device usage patterns and detected movements.

7. The method of claim 1, wherein processing the combined dataset to identify correlations includes utilizing a machine learning model, the machine learning model being trained to identify correlations between device usage patterns and detected movements, the training being based on previously recorded and labeled data of device usage and detected movements.

8. The method of claim 1, wherein the occupancy state comprises one or more of a presence of humans or a count of humans in the networked environment.

9. A non-transitory computer-readable storage medium for tangibly storing computer program instructions capable of being executed by a computer processor, the computer program instructions defining steps of:
classifying motion data and network device usage data in a networked environment;
integrating the classified motion data and the network device usage data to create a combined dataset;
processing the combined dataset to identify correlations between the motion data and the network device usage data; and
using the identified correlations to predict an occupancy state of the environment.

10. The non-transitory computer-readable storage medium of claim 9, wherein the motion data includes data related to micro-motions, the micro-motions indicating movements within the environment that do not significantly change a physical position of a device.

11. The non-transitory computer-readable storage medium of claim 9, wherein the network device usage data includes data associated with one or more of a connection of a device to a network, a disconnection of the device from the network, or network requests associated with the device.

12. The non-transitory computer-readable storage medium of claim 9, wherein classifying motion data comprises detecting motion events using a Digital Signal Processing (DSP) engine based on one or more of Channel State Information (CSI) or Channel Frequency Response (CFR) data received from a Wi-Fi access point.

13. The non-transitory computer-readable storage medium of claim 9, wherein integrating the classified motion data and the network device usage data comprises aligning the motion data and network device usage data based on timestamp data and using the alignment to determine relationships between network device usage data and motion data.

14. The non-transitory computer-readable storage medium of claim 9, wherein processing the combined dataset to identify correlations includes utilizing a plurality of rules, the plurality of rules defining relationships between device usage patterns and detected movements.

15. The non-transitory computer-readable storage medium of claim 9, wherein processing the combined dataset to identify correlations includes utilizing a machine learning model, the machine learning model being trained to identify correlations between device usage patterns and detected movements, the training being based on previously recorded and labeled data of device usage and detected movements.

16. The non-transitory computer-readable storage medium of claim 9, wherein the occupancy state comprises one or more of a presence of humans or a count of humans in the networked environment.

17. A device comprising:
a processor; and
a storage medium for tangibly storing thereon logic for execution by the processor, the logic comprising instructions for: classifying motion data and network device usage data in a networked environment;
integrating the classified motion data and the network device usage data to create a combined dataset,
processing the combined dataset to identify correlations between the motion data and the network device usage data, and
using the identified correlations to predict an occupancy state of the environment.

18. The device of claim 17, wherein the motion data includes data related to micro-motions, the micro-motions indicating movements within the environment that do not significantly change a physical position of a device.

19. The device of claim 17, wherein classifying motion data comprises detecting motion events using a Digital Signal Processing (DSP) engine based on one or more of Channel State Information (CSI) or Channel Frequency Response (CFR) data received from a Wi-Fi access point.

20. The device of claim 17, wherein the occupancy state comprises one or more of a presence of humans or a count of humans in the networked environment.
